(19) United States
(12) Patent Application Publication
(10) Pub. No.: US 2024/0272338 A1
(43) Pub. Date: Aug. 15, 2024

(54) Semi-Transparent Mirror

(71) Applicant: Vitro Flat Glass LLC, Cheswick, PA (US)

(72) Inventors: Farzad Fareed, San Diego, CA (US); Andrew V. Wagner, Pittsburgh, PA (US)

(21) Appl. No.: 18/439,238

(22) Filed: Feb. 12, 2024

Related U.S. Application Data
(60) Provisional application No. 63/445,387, filed on Feb. 14, 2023.

(51) Int. Cl. G02B 5/08; G02B 1/14

(52) U.S. Cl. CPC G02B 5/0833; G02B 1/14

(57) ABSTRACT

A semi-transparent mirror and method of producing the same are disclosed. An exemplary embodiment includes a coated article comprising a substrate, a first dielectric layer over at least a portion of the substrate, a second dielectric layer over at least a portion of the first dielectric layer, a third dielectric layer over at least a portion of the second dielectric layer, a fourth dielectric layer over at least a portion of the third dielectric layer, and a protective layer over at least a portion of the fourth dielectric layer.

### CROSS-REFERENCE TO RELATED APPLICATION

This application claims priority to U.S. Provisional Application No. 63/445,387 filed on Feb. 14, 2023, the disclosure of which is incorporated by reference in its entirety.

### BACKGROUND OF THE INVENTION

### Field of the Invention

This invention relates generally to a semi-transparent mirror with multiple dielectric layers and a method of making the same.

### Technical Considerations

Applying coatings to mirrors are known in the fields of transparent coatings. Such coatings may be applied to mirrors for protection purposes. However, other coatings, such as dielectric coatings may be applied to a mirror. Mirrors with dielectric layers may have electrical properties. Applying such layers may lead to altering reflectance and transmittance of light in the visible light wavelength such that a mirror may not be able to carry out its intended purpose of providing accurate reflections that may not be aesthetically desirable. It may be desirable to apply dielectric layers to a mirror such that the mirror can be used simultaneously used as a mirror and an electronic device.

### SUMMARY OF THE INVENTION

Accordingly, it is an object of the present disclosure to provide a semi-transparent mirror that has desirable reflectance and transmittance properties. In one aspect of the invention, a coated article comprises a substrate. A first dielectric layer is positioned over at least a portion of the substrate. The first dielectric layer comprises ZnSnO or TiO₂. A second dielectric layer is positioned over at least a portion of the first dielectric layer. The second dielectric layer comprises SiAlO. A third dielectric layer is positioned over at least a portion of the second dielectric layer. The third dielectric layer comprises ZnSnO or TiO₂. A fourth dielectric layer is positioned over at least a portion of the third dielectric layer. The fourth dielectric layer comprises ZnSnO or TiO₂. A protective layer is positioned over at least a portion of the fourth dielectric layer. The protective layer comprises ZnSnO or TiO₂.

In one broad aspect of the invention, the first electric layer and the third dielectric layer comprise ZnSnO. The first dielectric layer has a thickness in the range of 80 nm to 161 nm. The second dielectric layer has a thickness in the range of 26 nm to 138 nm. The third dielectric layer has a thickness in the range of 37 nm to 112 nm. The fourth dielectric layer has a thickness in the range of 67 nm to 101 nm. The protective layer has a thickness in the range of 3 nm to 61 nm. The coating stack further comprises a fifth dielectric layer. The fifth dielectric layer has a thickness in the range of 30 nm to 60 nm. The thickness of the second dielectric layer has a thickness range that is less than half of the thickness of the fourth dielectric layer. The fourth dielectric layer has a thickness range that is thicker than the thickness of the second dielectric layer.

In one broad aspect of the invention, the coated article has a light reflectance of at least 50% in the visible light spectrum. The coated article has a light reflectance range of 50% to 70%. The coated article has a color reflectance of L* in the range of 70 to 90. The coated article has a color transmittance of L* value in the range of 60 to 70. The fifth dielectric layer is disposed over at least a portion of the fourth dielectric layer. The fifth dielectric layer comprises ZnSnO. The fifth dielectric layer comprises TiO₂. The coated article further comprises a second protective layer over at least a portion of the protective layer. The second protective layer comprises zirconium oxide. The second protective layer has a thickness in the range of greater than 0 nm to 10 nm.

In another aspect, the invention is a method of making a coated article. The method comprises providing a substrate. A first dielectric layer is applied over at least a portion of the substrate at a thickness in the range of 80 nm to 161 nm. The first dielectric layer comprises a first high refractive index material. A second dielectric layer is applied over at least a portion of the first dielectric layer at a thickness in the range of 26 nm to 138 nm. The second dielectric layer comprises a first low refractive index material. A third dielectric layer is applied over at least a portion of the second dielectric layer at a thickness in the range of 37 nm to 112 nm. The third dielectric layer comprises a second high refractive index material. A fourth dielectric layer is applied over at least a portion of the third dielectric layer at a thickness in the range of 67 nm to 101 nm. The fourth dielectric material comprises a second low refractive index material. A protective layer is applied over at least a portion of the fourth dielectric layer at a thickness in the range of 3 nm to 61 nm. The first dielectric layer and the third dielectric layer comprise a metal oxide. The metal oxide is chosen from a group comprising ZnSnO or TiOₓ. The second and fourth dielectric layer comprises SiAlO. A fifth dielectric layer is applied at a thickness in the range of 30 nm to 60 nm.

### BRIEF DESCRIPTION OF THE DRAWINGS

The invention will be described with reference to the following drawing figures wherein like reference numbers identify like parts throughout.

FIG. 1 is a side view (not to scale) of an exemplary coating stack according to a non-limiting embodiment of the invention.

FIG. 2 is a side view (not to scale) of an exemplary coating stack according to a non-limiting embodiment of the invention.

FIG. 3 is a side view (not to scale) of an exemplary coating stack according to a non-limiting embodiment of the invention.

### DESCRIPTION OF THE PREFERRED EMBODIMENTS

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate. As used herein, the terms “polymer” or “polymeric” include oligomers, homopolymers, copolymers, and terpolymers, e.g., polymers formed from two or more types of monomers or polymers. The terms “visible region” or “visible light” refer to electromagnetic radiation having a wavelength in the range of 380 nm to 800 nm. The terms “infrared region” or “infrared radiation” refer to electromagnetic radiation having a wavelength in the range of greater than 800 nm to 100,000 nm. The terms “ultraviolet region” or “ultraviolet radiation” mean electromagnetic energy having a wavelength in the range of 300 nm to less than 380 nm. Additionally, all documents, such as, but not limited to, issued patents and patent applications, referred to herein are to be considered to be “incorporated by reference” in their entirety. As used herein, the term “film” refers to a coating region of a desired or selected coating composition. A “layer” can comprise one or more “films”, and a “coating” or “coating stack” can comprise one or more “layers”.

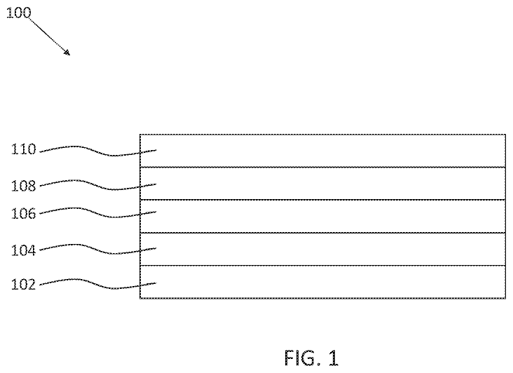

Referring to FIG. 1, according to a non-limiting embodiment, provided is a coating stack 100. The coating stack 100 may include one or more dielectric layers that may be applied to a mirror.

According to a non-limiting embodiment, the coating stack 100 may be applied to a substrate. The substrate may comprise plastic substrates (such as acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof); ceramic substrates; glass substrates; or mixtures or combinations of any of the above. For example, the substrate can include conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as, conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. Examples of float glass processes are disclosed in U.S. Pat. Nos. 4,466,562 and 4,671,155.

The coating stack 100 may include a first dielectric layer 102 deposited over at least a portion of a surface of a substrate. The first dielectric layer 102 can be a single film or can comprise more than one film. The first dielectric layer 102 may be deposited by any conventional method, such as, but not limited to, chemical vapor deposition (CVD) and/or any physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as, but not limited to, sol-gel deposition. In one non-limiting embodiment, the first dielectric layer 102 can be deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750.

The first dielectric layer 102 (whether a single film or multiple film layer) can have a thickness in the range of 80 nm to 161 nm, such as 90 nm to 150 nm, such as 94 nm to 140 nm. The first dielectric layer 102 may comprise a metal. The metal may be an oxide or a nitride. The metal may comprise any metal that provides a high refractive index. A high refractive index metal oxide or metal nitride would have a refractive index of at least 1.8, such as at least 1.9, such as at least 2.0, such as at least 2.1. These metals include titanium, indium, zirconium, cerium, antimony, zinc, tin, and mixtures thereof. Therefore, the first dielectric layer 102 may comprise oxides or nitrides of metals selected from the group consisting of titanium, zirconium, zinc, cerium, antimony, indium, tin, and mixtures thereof. The metal may be a metal alloy or mixture of metals, such as zinc and tin. The oxide or nitride of the metal may be zinc stannate (defined below), silicon nitrides, silicon aluminum nitrides, zinc-tin oxide, zinc oxide, tin oxide, titanium oxide or aluminum nitrides. The first dielectric layer 102 can be a substantially single phase film, such as a metal alloy oxide film, e.g., zinc stannate, or can be a mixture of phases composed of zinc and tin oxides or can be composed of a plurality of films. By “zinc stannate” is meant a composition of Zn_{X}Sn_{1-X}O_{2-X} (Formula 1) where “x” varies in the range of greater than 0 to less than 1. For instance, “x” can be greater than 0 and can be any fraction or decimal between greater than 0 to less than 1. For example, where x=⅔, Formula 1 is Zn_{2/3}Sn_{1/3}O_{4/3}, which is more commonly described as “Zn₂SnO₄”. A zinc stannate-containing film has one or more of the forms of Formula 1 in a predominant amount in the film. The first dielectric layer 102 may comprise titanium oxide, defined as a compound comprising both titanium and oxygen. The titanium oxide may comprise, for example, titanium oxide, titanium aluminum oxide, titanium oxynitride, titanium aluminum oxynitride, or any mixtures thereof. The titanium oxide may comprise a titanium metal oxide, such as titanium aluminum oxide. In one embodiment, the first dielectric layer 102 comprises zinc stannate. In another embodiment, the first dielectric layer 102 comprises titanium oxide.

A second dielectric layer 104 may be located over the first dielectric layer 102. For example, the second dielectric layer 104 may be deposited over at least a portion of the first dielectric layer 102 via any methods, such as those described above. The second dielectric layer 104 may comprise one or more metals that are deposited as an oxide or a nitride. The second dielectric layer 104 (whether a single film or multiple film layer) may have a thickness in the range of 26 nm to 138 nm, such as 28 nm to 127 nm, such as 31 nm to 120 nm. The second dielectric layer 104 has a low refractive index, which is lower than the refractive index of the first dielectric layer. For example, the second dielectric layer can comprises a refractive index of no more than 1.8, such as no more than 1.75. The metal for the second dielectric layer may comprise silicon, aluminum, or a mixture thereof. The metal may be a metal alloy comprising silicon and aluminum. For example, the metal alloy may comprise 70 to 90 weight percent silicon, such as 75 to 90 weight percent silicon, such as 80 to 90 weight percent silicon, such as approximately 85 weight percent of silicon; and 10 to 30 weight percent of aluminum, such as 10 to 25 weight percent of aluminum, such as 10 to 20 weight percent of aluminum, such as approximately 15 weight percent of aluminum. The metal alloy may be an oxide comprising the silicon and aluminum described above.

A third dielectric layer 106 may be located over the second dielectric layer 104. The third dielectric layer 106 has a high refractive index, as discussed above with respect to the first dielectric layer 102. For example, the third dielectric layer 106 may be deposited over at least a portion of the second dielectric layer 104 via any methods, such as those described above. The third dielectric layer 106 (whether a single film or multiple film layer) may have a thickness in the range of 37 nm to 112 nm, such as 40 nm to 105 nm, such as 44 nm to 97 nm.

A fourth dielectric layer 108 may be located over the third dielectric layer 106. The fourth dielectric layer 108 has a low refractive index, as discussed above with respect to the second dielectric layer 104. For example, the fourth dielectric layer 108 may be deposited over at least a portion of the third dielectric layer 106 via any methods, such as those described above. The fourth dielectric layer 108 may comprise one or more metal oxides or metal alloy oxide-containing films, such as those described above with respect to the second dielectric layer 104. The fourth dielectric layer 108 (whether a single film or multiple film layer) can have a thickness in the range of 67 nm to 101 nm, such as 73 nm to 94 nm, such as 79 nm to 88 nm.

A protective layer 110 may be located over the fourth dielectric layer 108. The protective layer 110 may have high or low refractive index, as discussed above with respect to the first dielectric layer 102 and the second dielectric layer 104. For example, the protective layer 110 may be deposited over at least a portion of the fourth dielectric layer 108 via any methods, such as those described above. The protective layer 110 (whether a single film or multiple film layer) can have a thickness in the range of 3 nm to 61 nm, such as 4 nm to 57 nm, such as 5 nm to 53 nm. The protective layer 110 may comprise at least one of Si₃N₄, SlAlN, SlAlON, TlO₂, TiAlO, silica, zirconia, or combinations thereof.

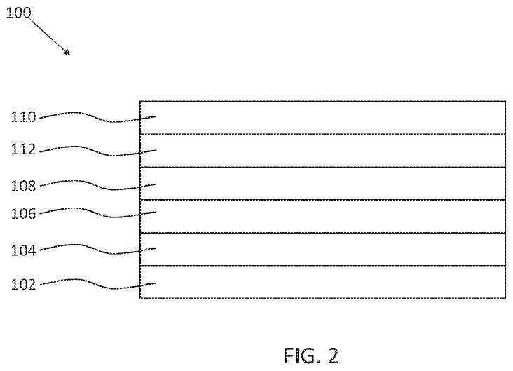

Referring to FIG. 2, according to another non-limiting embodiment, the coating stack 100, as discussed above with respect to FIG. 1, may further include a fifth dielectric layer 112. The fifth dielectric layer 112 may have high refractive index, as discussed above with respect to the first dielectric layer 102. For example, the fifth dielectric layer 112 may be deposited over at least a portion of the fourth dielectric layer 108 and between the fourth dielectric layer 108 and the protective layer 110. The fifth dielectric layer 112 may comprise one or more metal oxides or metal alloy oxide-containing films, such as those described above with respect to the first dielectric layer 102. The fifth dielectric layer 112 may be a protective layer. The fifth dielectric layer 112 may have any desirable thickness, such as 30 nm to 60 nm, such as 35 nm to 55 nm, such as 40 nm to 50 nm.

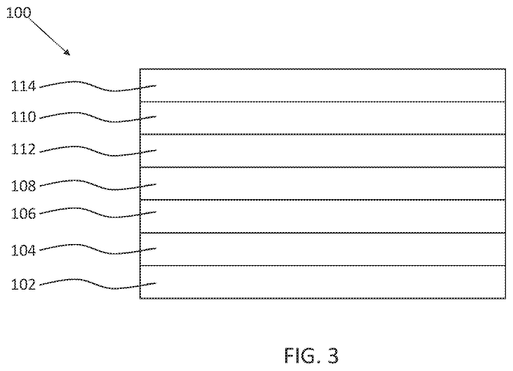

Referring to FIG. 3, according to another non-limiting embodiment, the coating stack 100, as discussed with respect to FIGS. 1 and 2, may further include a second protective layer 114. The second protective layer 114 has high refractive index, as discussed above with respect to the first dielectric layer 102. For example. The second protective layer 114 may be deposited over at least a portion of the protective layer 110 via any methods, as such those described above. The second protective layer 114 may comprise one or more metal oxides or metal alloy oxide-containing films, such as those described with respect to the protective layer 110. The second protective layer 114 may have any desirable thickness, such as greater than 0 nm to 10 nm, such as 1.5 nm to 8 nm, such as 3 nm to 5 nm.

Referring to FIGS. 1-3, according to a non-limiting embodiment, the second dielectric layer 104 may have a thickness that is less than the fourth dielectric layer 108. For example, the thickness of the second dielectric layer may be less than 75% of the fourth dielectric layer 108; or less than half of the thickness of the fourth dielectric layer 108. Alternatively, the fourth dielectric layer 108 may have a thickness that is less than the thickness of the second dielectric layer 104. For example, the fourth dielectric layer 108 may have a thickness that is less than 75% the thickness of the second dielectric layer 104; or less than 70% the thickness of the second dielectric layer; or less than 65% of the thickness of the second dielectric layer; or less than 60% of the thickness of the second dielectric layer; or less than 55% of the thickness of the second dielectric layer; or less than 50% of the thickness of the second dielectric layer.

According to a non-limiting embodiment, the coating stack 100 may have a light reflectance of at least 50%, such as 50% to 100%, 50% to 80%, 50% to 70%, 55% to 65%, 57% to 61%. The coated article may have varying color reflectance properties. For example, coating stack 100 may have a color reflectance of L* value in the range of 65 to 95, such as 70 to 90. The coating stack 100 may have a color reflectance of a* value in the range of −3 to 5, such as −2.5 to 3.5. The coating stack 100 may have a color reflectance of b* value in the range of 0 to 10, such as 2 to 10. The coating stack 100 may have a color transmittance of L* value in the range of 60 to 70. The coating stack 100 may have a color transmittance of a* value in the range of −3.0 to 2.5. The coating stack 100 may have a color transmittance of b* value in the range of −4.0 to −2.0.

Other non-limiting embodiments or aspects will be set forth in the following numbered clauses:
Clause 1: A coated article comprising: a substrate; a first dielectric layer over at least a portion of the substrate, the first dielectric layer is comprised of a material, wherein the material is chosen from a group comprising ZnSnO or TiO₂; a second dielectric layer over at least a portion of the first dielectric layer, the second dielectric layer comprising SiAlO; a third dielectric layer over at least a portion of the second dielectric layer, the third dielectric layer is comprised of a material, wherein the material is chosen from a group comprising ZnSnO or TiO₂; a fourth dielectric layer over at least a portion of the third dielectric layer, the fourth dielectric layer comprising SiAlO; and a protective layer over at least a portion of the fourth dielectric layer, the protective layer is comprised of a material, wherein the material is chosen from a group comprising ZnSnO, or TiO₂.
Clause 2: The coated article of clause 1, wherein the first layer and the third layer comprise ZnSnO.
Clause 3: The coated article of clause 1, wherein the first layer and the third layer comprise TiO₂.
Clause 4: The coated article of any of clauses 1, wherein the first dielectric layer has a thickness in the range of 80 nm to 161 nm, preferably 90 nm to 150 nm, more preferably as 94 nm to 140.
Clause 5: The coated article of clause 1, wherein the second dielectric layer has a thickness in the range of 26 nm to 138 nm, preferably 28 nm to 127 nm, more preferably 31 nm to 120 nm.
Clause 6: The coated article of clause 1, wherein the third dielectric layer has a thickness in the range of 37 nm to 112 nm, preferably 40 nm to 105 nm, more preferably 44 nm to 97 nm.
Clause 7: The coated article of clause 1, wherein the fourth dielectric layer has a thickness in the range of 67 nm to 101 nm, preferably 73 nm to 94 nm, more preferably 79 nm to 88 nm.
Clause 8: The coated article of clause 1, wherein the protective layer has a thickness in the range of 3 nm to 61 nm, preferably 4 nm to 57 nm, more preferably 5 nm to 53 nm.
Clause 9: The coated article of clause 1, wherein the coating stack further comprises a fifth dielectric layer, the fifth dielectric layer having a thickness in the range of 30 nm to 60 nm, such as 35 nm to 55 nm, such as 40 nm to 50 nm.
Clause 10: The coated article of clause 1, wherein the thickness of the second dielectric layer has a thickness range that is less than half the thickness of the fourth dielectric layer.
Clause 11: The coated article of clause 1, wherein the thickness of the fourth dielectric layer has a thickness range that is thicker than the thickness of the second dielectric layer.
Clause 12: The coated article of clause 1, wherein the coated article has a light reflectance of at least 50% in the visible light spectrum.
Clause 13: The coated article of clause 1, wherein the coated article has a light reflectance range of 50% to 70%.
Clause 14: The coated article of clause 1, wherein the coated article has a color reflectance of L* value in the range of 70 to 90.
Clause 15: The coated article of clause 1, wherein the coated article has a color transmittance of L* value in the range of 60 to 70.
Clause 16: The coated article of clause 1, wherein the fifth dielectric layer is disposed over at least a portion of the fourth dielectric layer.
Clause 17: The coated article of clause 1, wherein the fifth dielectric layer comprises ZnSnO or TiO₂.
Clause 18: The coated article of clause 1 further comprising a second protective layer over at least a portion of the protective layer.
Clause 19: The coated article of clause 1, wherein the second protective layer comprises zirconium oxide.
Clause 20: The coated article of clause 1, wherein the second protective layer has a thickness range of greater than 0 nm to 10 nm, preferably 1.5 nm to 8 nm, more preferably 3 nm to 5 nm.
Clause 21: A method of making a coated article comprising: providing a substrate; applying a first dielectric layer having a thickness in the range of 80 nm to 161 nm, preferably 90 nm to 150 nm, more preferably 94 nm to 140 nm over at least a portion of the substrate, wherein the first dielectric layer comprises a first high refractive index material; applying a second dielectric layer having a thickness in the range of 26 nm to 138 nm, preferably 28 nm to 127 nm, more preferably 31 nm to 120 nm over at least a portion of the first dielectric layer, wherein the second dielectric layer has a first low refractive index material; applying a third dielectric layer having a thickness in the range of 37 nm to 112 nm, preferably 40 nm to 105 nm, more preferably 44 nm to 97 nm over at least a portion of the second dielectric layer, wherein the third dielectric layer comprises a second high refractive index material; applying a fourth dielectric layer having a thickness in the range of 67 nm to 101 nm, preferably 73 nm to 94 nm, more preferably 79 nm to 88 nm over at least a portion of the third dielectric layer, wherein the fourth dielectric layer comprises a second low refractive index material; and applying a protective layer having a thickness in the range 3 nm to 61 nm, preferably 4 nm to 57 nm, more preferably 5 nm to 53 nm over at least a portion of the fourth dielectric layer.
Clause 22: The method of clause 21, wherein the first and third dielectric layers comprise a metal oxide.
Clause 23: The method of clause 22, wherein the metal oxide is chosen from a group comprising: ZnSnO, or TiₓO.
Clause 24: The method of any of clauses 21, wherein the second and fourth dielectric layer comprises SiAlO.
Clause 25: The method of any of clause 21 further comprising applying a fifth dielectric layer having a thickness in the range of 30 nm to 60 nm, such as 35 nm to 55 nm, such as 40 nm to 50 nm.

### EXAMPLES

### Example 1

A coating stack, as shown in Table 1, was manufactured by a conventional MSVD method. The optical characteristics are shown in Tables 5-7 below.

TABLE 1

| Layer | Material | Thickness (nm) |
|---|---|---|
| First layer | ZnSn | 140 |
| Second layer | Si₈₅Al | 31 |
| Third layer | ZnSn | 97 |
| Fourth layer | Si₈₅Al | 79 |
| Fifth layer | ZnSn | 22 |
| Protective layer | TiO₂ | 35 |

### Example 2

A coating stack, as shown in Table 2, was manufactured by a conventional MSVD method. The optical characteristics are shown in Tables 5-7 below.

TABLE 2

| Layer | Material | Thickness (nm) |
|---|---|---|
| First layer | ZnSn | 134 |
| Second layer | Si₈₅Al | 69 |
| Third layer | ZnSn | 61 |
| Fourth layer | Si₈₅Al | 85 |
| Fifth layer | ZnSn | 11 |
| Protective layer | TiO₂ | 50 |

### Example 3

A coating stack, as shown in Table 3, was manufactured by a conventional MSVD method. The optical characteristics are shown in Tables 5-7 below.

TABLE 3

| Layer | Material | Thickness (nm) |
|---|---|---|
| First layer | ZnSn | 138 |
| Second layer | Si₈₅Al | 42 |
| Third layer | ZnSn | 73 |
| Fourth layer | Si₈₅Al | 88 |
| Fifth layer | ZnSn | 5 |
| Protective layer | TiO₂ | 50 |

### Example 4

A coating stack, as shown in Table 4, was manufactured by a conventional MSVD method. The optical characteristics are shown in Tables 7-9 below.

TABLE 4

| Layer | Material | Thickness (nm) |
|---|---|---|
| First layer | TiO₂ | 94 |
| Second layer | Si₈₅Al | 120 |
| Third layer | TiO₂ | 44 |
| Fourth layer | Si₈₅Al | 83 |
| Protective layer | TiO₂ | 53 |

### Example 5

A coating stack, as shown in Table 5, was manufactured by a conventional MSVD method.

TABLE 5

| Layer | Material | Thickness (nm) |
|---|---|---|
| First layer | ZnSn | 131 |
| Second layer | Si₈₅Al | 46 |
| Third layer | ZnSn | 82 |
| Fourth layer | Si₈₅Al | 82 |
| Fifth layer | ZnSn | 9 |
| Protective layer | TiO₂ | 47 |

### Example 6

A coating stack, as shown in Table 6, was manufactured by a conventional MSVD method.

TABLE 6

| Layer | Material | Thickness (nm) |
|---|---|---|
| First layer | ZnSn | 131 |
| Second layer | Si₈₅Al | 46 |
| Third layer | ZnSn | 82 |
| Fourth layer | Si₈₅Al | 82 |
| Fifth layer | ZnSn | 9 |
| Protective layer | TiO₂ | 47 |
| Second Protective Layer | ZrO₂ | 4 |

TABLE 7

| Example | Reflectance | Transmission |
|---|---|---|
| 1 | 52% | 48% |
| 2 | 61% | 39% |
| 3 | 58.6% | 40.6% |
| 4 | 73% | 27% |
| 5 | 57-58% | 43-42% |
| 6 | 57-58% | 43-42% |

TABLE 8

| Example | 8-RfL | 8-Rfa | 8-Rfb | 8-TL | 8-Ta | 8-Tb |
|---|---|---|---|---|---|---|
| 1 | 77.1 | 0.9 | 4.1 | 74.5 | −2.5 | −2.1 |
| 2 | 82.2 | −2.3 | 0.0 | 68.5 | 1.7 | 1.6 |
| 3 | 81.1 | −0.2 | 0.2 | 69.9 | −1.1 | 1.3 |
| 4 | 88.3 | 1.6 | 0.0 | 58.8 | −3.7 | 0.0 |

TABLE 9

| Ex- | 8- | 8- | 8- | 8- | 8- | 8- |
|---|---|---|---|---|---|---|
| am- | RfDab/ | RfDab/ | RfDab/ | RfDab/ | RfDab/ | RfDab/ |
| ple | d3 | d4 | d5 | d6 | d7 | d8 |
| 1 | 0.64 | 0.23 | 0.56 | 0.55 | 0.26 | 0.41 |
| 2 | 0.72 | 0.15 | 0.57 | 0.77 | 0.15 | 0.76 |
| 3 | 1.04 | 0.07 | 0.55 | 0.79 | 0.06 | — |
| 4 | 0.62 | 0.23 | 0.42 | 0.55 | 0.57 | 0.00 |

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

The invention claimed is:

1. A coated article comprising:
a substrate;
a first dielectric layer over at least a portion of the substrate, the first dielectric layer comprises ZnSnO or TiO₂;
a second dielectric layer over at least a portion of the first dielectric layer, the second dielectric layer comprises SiAlO;
a third dielectric layer over at least a portion of the second dielectric layer, the third dielectric layer comprises ZnSnO or TiO₂;
a fourth dielectric layer over at least a portion of the third dielectric layer, the fourth dielectric layer comprises SiAlO; and
a protective layer over at least a portion of the fourth dielectric layer, the protective layer comprises ZnSnO or TiO₂.

2. The coated article of claim 1, wherein the first dielectric layer and the third dielectric layer comprise ZnSnO.

3. The coated article of claim 1, wherein the first dielectric layer has a thickness in the range of 80 nm to 161 nm.

4. The coated article of claim 1, wherein the second dielectric layer has a thickness in the range of 26 nm to 138 nm.

5. The coated article of claim 1, wherein the third dielectric layer has a thickness in the range of 37 nm to 112 nm.

6. The coated article of claim 1, wherein the fourth dielectric layer has a thickness in the range of 67 nm to 101 nm.

7. The coated article of claim 1, wherein the protective layer has a thickness in the range of 3 nm to 61 nm.

8. The coated article of claim 1, wherein the coating stack further comprises a fifth dielectric layer, the fifth dielectric layer having a thickness in the range of 30 nm to 60 nm.

9. The coated article of claim 1, wherein the thickness of the second dielectric layer has a thickness range that is less than half of the thickness of the fourth dielectric layer.

10. The coated article of claim 1, wherein the thickness of the fourth dielectric layer has a thickness range that is thicker than the thickness of the second dielectric layer.

11. The coated article of claim 1, wherein the coated article has a light reflectance of at least 50% in the visible light spectrum.

12. The coated article of claim 1, wherein the coated article has a light reflectance range of 50% to 70%.

13. The coated article of claim 1, wherein the coated article has a color reflectance of L* value in the range of 70 to 90.

14. The coated article of claim 1, wherein the coated article has a color transmittance of L* value in the range of 60 to 70.

15. The coated article of claim 1, wherein the fifth dielectric layer is disposed over at least a portion of the fourth dielectric layer.

16. The coated article of claim 14, wherein the fifth dielectric layer comprises ZnSnO or TiO₂.

17. The coated article of claim 1 further comprising a second protective layer over at least a portion of the protective layer.

18. The coated article of claim 17, wherein the second protective layer comprises zirconium oxide.

19. The coated article of claim 17, wherein the second protective layer has a thickness range of greater than 0 nm to 10 nm.

20. A method of making a coated article comprising:
providing a substrate;
applying a first dielectric layer having a thickness in the range of 80 nm to 161 nm over at least a portion of the substrate, wherein the first dielectric layer comprises a first high refractive index material;
applying a second dielectric layer having a thickness in the range of 26 nm to 138 nm over at least a portion of the first dielectric layer, wherein the second dielectric layer comprises a first low refractive index material;
applying a third dielectric layer having a thickness in the range of 37 nm to 112 nm over at least a portion of the second dielectric layer, wherein the third dielectric layer comprises a second high refractive index material;
applying a fourth dielectric layer having a thickness in the range of 67 nm to 101 nm over at least a portion of the third dielectric layer, wherein the fourth dielectric layer comprises a second low refractive index material; and
applying a protective layer having a thickness in the range of 3 nm to 61 nm over at least a portion of the fourth dielectric layer.
